(19) United States
(12) Patent Application Publication
(10) Pub. No.: US 2021/0273542 A1
(43) Pub. Date: Sep. 2, 2021

(54) STATOR ASSEMBLY FOR A HYBRID MODULE

(71) Applicant: Schaeffler Technologies AG & Co. KG, Herzogenaurach (DE)

(72) Inventors: Matthew Payne, Glenmont, OH (US); Micah Steiner, Smithville, OH (US)

(73) Assignee: Schaeffler Technologies AG & Co. KG, Herzogenaurach (DE)

(21) Appl. No.: 17/183,709

(22) Filed: Feb. 24, 2021

Related U.S. Application Data
(60) Provisional application No. 62/983,657, filed on Feb. 29, 2020.

(51) Int. Cl. H02K 24/00; H02K 7/10; H02K 11/225

(52) U.S. Cl. CPC H02K 24/00; H02K 7/10; B60Y 2400/60; B60Y 2200/91; H02K 11/225

(57) ABSTRACT

A stator assembly for a hybrid module comprises a stator carrier including an axially extending portion and a radially extending portion. A stator segment is disposed on an inner surface of the axially extending portion of the stator carrier. The radially extending portion extends away from the stator segment in a radially inward direction toward an axis of rotation. A resolver stator is fixed to the radially extending portion of the stator carrier and the resolver stator is disposed radially inward of the stator segment.

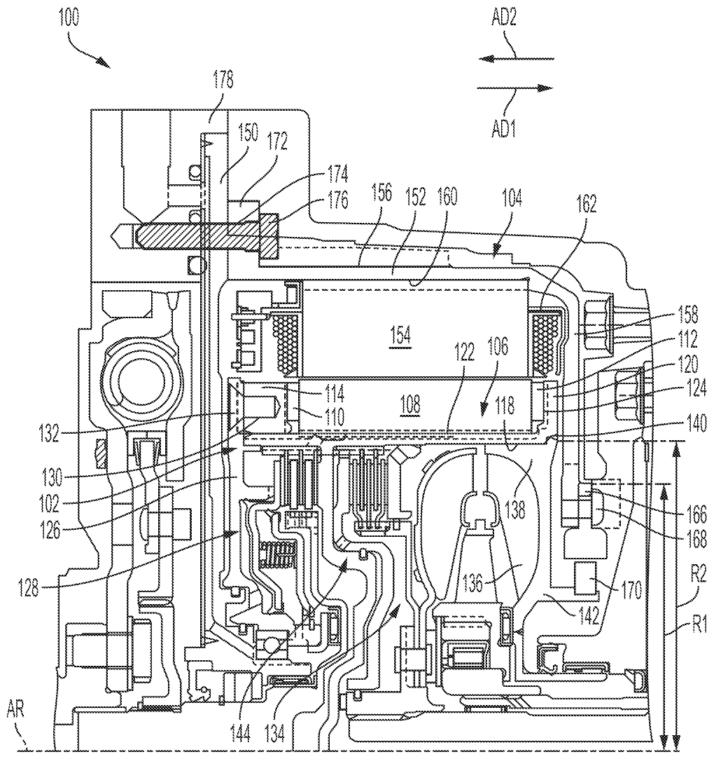

### CROSS-REFERENCE TO RELATED APPLICATIONS

This application claims priority to U.S. Provisional Application No. 62/983,657 filed Feb. 29, 2020, the entire disclosure of which is incorporated herein by reference.

### TECHNICAL FIELD

The present disclosure relates generally to a hybrid module and, more specifically, to a stator assembly for a hybrid module.

### BACKGROUND

Hybrid modules are generally known. Often, it is a challenge to package and/or fit all the desired components, e.g., an e-motor, crank damper, torque converter, torque converter clutch, disconnect clutch, and resolver within the hybrid module architecture due to axial constraints.

### SUMMARY

In general, embodiments of the present disclosure provide a stator assembly for a hybrid module comprising a stator carrier including an axially extending portion and a radially extending portion. A stator segment is disposed on an inner surface of the axially extending portion of the stator carrier. The radially extending portion extends away from the stator segment in a radially inward direction toward an axis of rotation. A resolver stator is fixed to the radially extending portion of the stator carrier and the resolver stator is disposed radially inward of the stator segment.

In embodiments, the resolver stator may be fixed to the radially extending portion via a bolted connection. The stator segment may be installed on the inner surface by shrink fitting. The stator carrier may further include a radial extension extending radially outward from the axially extending portion and the radial extension may be fixed to a housing of the hybrid module. The radial extension may include an opening defined therein for receiving a connector, for example a bolt, to fix the stator carrier to the housing of the hybrid module. The radial extension extends radially outward from a first end of the axially extending portion of the stator carrier and the radially extending portion extends radially inward from a second end, opposite the first end, of the axially extending portion of the stator carrier. The radially extending portion of the stator carrier extends around an outside of stator end windings of the stator segment.

In other embodiments, a hybrid module is provided comprising a stator assembly including a stator carrier having an axially extending portion and a radially extending portion; a stator segment disposed on an inner surface of the axially extending portion of the stator carrier; and a resolver stator fixed to the radially extending portion of the stator carrier, wherein the resolver stator is disposed radially inward of the stator segment. The hybrid module further includes a rotor assembly disposed radially inside of the stator assembly and including a rotor carrier; a torque converter impeller shell fixed to the rotor carrier; a flange fixed to the impeller shell and extending axially away from the impeller shell; and a resolver rotor fixed to the flange and axially aligned with the resolver stator.

In embodiments, the flange and the impeller shell may be of integral construction. The flange extends axially beyond the rotor carrier. The radially extending portion of the stator carrier extends radially inward of the rotor carrier toward an axis of rotation. The radially extending portion of the stator carrier extends around an outside of stator windings of the stator segment and the rotor carrier. The resolver stator may be fixed to the radially extending portion of the stator carrier by a connector. The resolver stator and the resolver rotor are disposed radially inward of the rotor carrier. A first radial distance of the resolver stator from an axis of rotation is less than a second radial distance of the rotor carrier from the axis of rotation. The resolver rotor may be fixed to the flange via staking. And, in embodiments, a line drawn normal to an axis of rotation extends through both the resolver stator and the resolver rotor.

### BRIEF DESCRIPTION OF THE DRAWINGS

The single FIGURE shows a partial cross-sectional view of a hybrid module according to an embodiment of the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The single FIGURE illustrates a partial cross-sectional view of hybrid module 100 according to an embodiment of the present disclosure. Hybrid module 100 includes rotor assembly 102 and stator assembly 104. Rotor assembly 102 includes rotor carrier 106, rotor segment 108, spring end plate 110, spring end plate 112, and end ring 114. Rotor carrier 106 includes axially extending portion 118 and radially extending portion 120. Axially extending portion 118 includes outer surface 122 and radially extending section 120 includes radial surface 124. The terms axially, radially and circumferentially as used herein are used with respect to axis of rotation AR.

Rotor segment 108 is installed and arranged on outer surface 122 of axially extending portion 118 of rotor carrier 106. In one embodiment, rotor segment 108 may be comprised of a stack of segments. Spring end plates 110, 112 are assembled on opposite axial sides of rotor segment 108. End ring 114 is fixed to outer surface 122 of axially extending portion 118 of rotor carrier 106 adjacent to spring end plate 110 and is arranged to act as a grounding component for disconnect clutch cover 126 of disconnect clutch 128. In this way, spring end plate 110 is disposed axially between end ring 114 and rotor segment 108, and spring end plate 112 is disposed axially between rotor segment 108 and radial surface 124 of radially extending portion 120 of rotor carrier 106. End ring 114 is configured to compress spring end plates 110, 112 to clamp and/or secure rotor segment 108 to rotor carrier 106.

During assembly, spring end plate 110 and spring end plate 112 are mounted in an initial, uncompressed state. That is, spring end plates 110, 112 will have a tapered profile. End ring 114 is then assembled on rotor carrier 106 and then pressed down with load to compress both spring end plate 110 and spring end plate 112. That is, end ring 114 presses spring end plate 110, rotor segment 108, and spring end plate 112 against radial surface 124 of radially extending portion 120 of rotor carrier 106 to clamp rotor segment 108 to rotor carrier 106 for frictional torque transmission therebetween. End ring 114 is then welded to rotor carrier 106. In this way, the clamp load generated by the compressed spring end plates 110, 112 is routed between rotor carrier 106 and rotor segment 108 and thereby clamp rotor segment 108 to rotor carrier 106. Spring end plates 110, 112 are of a non-magnetic material or of low magnetic permeability to prevent the magnetic flux from shorting between rotor magnets. In one embodiment, spring end plates 110, 112 are made of a stainless-steel material. This, in turn, provides sufficient strength and ductility to generate the necessary clamp load to hold the rotor inertia due to engine vibrations. Higher clamp loads can be attained by thickening spring end plates 110, 112. Moreover, the stainless-steel grade also prevents the magnetic flux from the magnets from shorting to each other. In this way, spring end plates 110, 112 acts as a rotor clamping feature for fixing rotor segment 108 to rotor carrier 106, as well as preventing magnets in the rotor from shorting the magnetic flux.

End ring 114 further includes threaded opening 130 defined therein for receiving one or more bolts 132 to connect disconnect clutch cover 126 to end ring 114. In this way, the full length of end ring 114 can be used to strengthen the bolting connection on account of that taking up the axial load of reacting the disconnect clutch 128 apply. Threaded opening 130 of end ring 114 is disposed radially outside of outer surface 122 of rotor carrier 106.

Hybrid module 100 further includes torque converter assembly 134 including impeller 136 having impeller shell 138 fixed to rotor carrier 106, wherein impeller shell 138 and rotor carrier 106 together form a housing for torque converter 134. Torque converter 134 is disposed radially inside rotor carrier 106. Impeller shell 138 may be fixed to rotor carrier 106 at weld 140, for example. Flange 142 is fixed to impeller shell 138 and extends axially away from impeller shell 138 in axial direction AD1 that is opposite axial direction AD2. Impeller shell 138 and flange 142 may be of integral construction, for example. Flange 142 extends axially beyond rotor carrier 106. Lock-up clutch 144 is disposed within torque converter 134 housing.

Stator assembly 104 is disposed radially outside of the rotor assembly 102 and is fixed to module housing 150. Stator assembly 104 includes stator carrier 152 and stator segment 154. In one embodiment, stator segment 154 may be a stack of stator segments. Stator carrier 152 includes axially extending portion 156 and radially extending portion 158. Axially extending portion 156 includes inner surface 160. Stator segment 154 is installed and arranged on inner surface 160. In one embodiment, stator segment 154 may be installed on stator carrier 152 via a shrink fit arrangement. That is, stator carrier 152 is heated to expand inner surface 160, stator segment 154 is installed on stator carrier 152, and inner surface 160 shrink fits to stator segment 154 after stator carrier 152 cools. Radially extending portion 158 of stator carrier 152 extends radially inward of rotor assembly 102 toward torque converter 134 and axis of rotation AR. That is, radially extending portion 158 extends away from stator segment 154 and rotor segment 108 in a radially inward direction toward axis of rotation AR. Radially extending portion 158 extends around stator end windings 162 and rotor carrier 106.

Stator assembly 104 includes resolver stator 166 fixed to the radially extending portion 158. In one embodiment, resolver stator 166 is fixed to radially extending portion 158 of stator carrier 152 by connector 168, which may be a bolt, for example. However, it is to be understood that other fixing methods (e.g., riveting, staking, adhesives) may be employed in other embodiments (not shown). Resolver stator 166 is disposed radially inward of rotor carrier 106. That is, radial distance R1 of resolver stator 166 measured from axis of rotation AR is less than radial distance R2 of rotor carrier 106 measured from axis of rotation AR.

Stator assembly 104 also includes resolver rotor 170 fixed to impeller 136. That is, resolver rotor 170 is fixed to flange 142 that extends axially away from impeller shell 138. Resolver rotor 170 may be fixed to flange 142 via staking, for example. Resolver rotor 170 is axially aligned with resolver stator 166. That is, a line can be drawn normal to axis of rotation AR that extends or passes through both resolver stator 166 and resolver rotor 170. Resolver rotor 170 is disposed radially inward of resolver stator 166 and rotor carrier 106.

Stator carrier 152 is arranged to fix stator assembly 104 to module housing 150. That is, stator carrier 152 includes radial extension 172 extending radially outward from axially extending portion 156 of stator carrier 152. Radial extension 172 includes opening 174 defined therein for receiving connector 176 to fix stator carrier 152 to module housing 150 and module spacer 178 to secure the components to each other. In example embodiments, connector 176 may be a bolt or other type of fastener.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 hybrid module
102 rotor assembly
104 stator assembly
106 rotor carrier
108 rotor segment
110 spring end plate
112 spring end plate
114 end ring
118 axially extending portion
120 radially extending portion
122 outer surface
124 radial surface
126 disconnect clutch cover
128 disconnect clutch
130 opening
132 bolts
134 torque converter assembly
136 impeller
138 impeller shell
140 weld
142 flange
144 lockup clutch
150 module housing
152 stator carrier
154 stator segment
156 axially extending portion
158 radially extending portion
160 inner surface
162 stator end windings
166 resolver stator
168 connector
170 resolver rotor
172 radial extension
174 opening
176 connector
178 module spacer

What is claimed is:

1. A stator assembly for a hybrid module, comprising:
a stator carrier including an axially extending portion and a radially extending portion;
a stator segment disposed on an inner surface of the axially extending portion of the stator carrier, wherein the radially extending portion extends away from the stator segment in a radially inward direction toward an axis of rotation; and
a resolver stator fixed to the radially extending portion of the stator carrier, wherein the resolver stator is disposed radially inward of the stator segment.

2. The stator assembly according to claim 1, wherein the resolver stator is fixed to the radially extending portion via a bolted connection.

3. The stator assembly according to claim 1, wherein the stator segment is installed on the inner surface by shrink fitting.

4. The stator assembly according to claim 1, wherein:
the stator carrier further includes a radial extension extending radially outward from the axially extending portion; and
the radial extension is fixed to a housing of the hybrid module.

5. The stator assembly according to claim 4, wherein the radial extension includes an opening defined therein for receiving a connector to fix the stator carrier to the housing of the hybrid module.

6. The stator assembly according to claim 4, wherein:
the radial extension extends radially outward from a first end of the axially extending portion of the stator carrier; and
the radially extending portion extends radially inward from a second end, opposite the first end, of the axially extending portion of the stator carrier.

7. The stator assembly according to claim 1, wherein the radially extending portion of the stator carrier extends around an outside of stator end windings of the stator segment.

8. A hybrid module, comprising:
a stator assembly including:
a stator carrier having an axially extending portion and a radially extending portion;
a stator segment disposed on an inner surface of the axially extending portion of the stator carrier; and
a resolver stator fixed to the radially extending portion of the stator carrier, wherein the resolver stator is disposed radially inward of the stator segment;
a rotor assembly disposed radially inside of the stator assembly and including:
a rotor carrier;
a torque converter impeller shell fixed to the rotor carrier;
a flange fixed to the impeller shell and extending axially away from the impeller shell; and
a resolver rotor fixed to the flange and axially aligned with the resolver stator.

9. The hybrid module according to claim 8, wherein the flange and the impeller shell are of integral construction.

10. The hybrid module according to claim 8, wherein the flange extends axially beyond the rotor carrier.

11. The hybrid module according to claim 8, wherein the radially extending portion of the stator carrier extends radially inward of the rotor carrier toward an axis of rotation.

12. The hybrid module according to claim 8, wherein the radially extending portion of the stator carrier extends around an outside of stator windings of the stator segment and the rotor carrier.

13. The hybrid module according to claim 8, wherein the resolver stator is fixed to the radially extending portion of the stator carrier by a connector.

14. The hybrid module according to claim 8, wherein the resolver stator and the resolver rotor are disposed radially inward of the rotor carrier.

15. The hybrid module according to claim 8, wherein a first radial distance of the resolver stator from an axis of rotation is less than a second radial distance of the rotor carrier from the axis of rotation.

16. The hybrid module according to claim 8, wherein the resolver rotor is fixed to the flange via staking.

17. The hybrid module according to claim 8, wherein a line drawn normal to an axis of rotation extends through both the resolver stator and the resolver rotor.
